(19) United States
(12) Patent Application Publication
(10) Pub. No.: US 2010/0297304 A1
(43) Pub. Date: Nov. 25, 2010

(54) BEVERAGE CAPSULES

(75) Inventor: David Fackrell, Shropshire (GB)

Correspondence Address: CANTOR COLBURN LLP, 20 Church Street, 22nd Floor, Hartford, CT, 06103, US

(73) Assignee: CADBURY HOLDINGS LIMITED, Middlesex (GB)

(21) Appl. No.: 12/810,371

(22) PCT Filed: Dec. 19, 2008
(86) PCT No.: PCT/GB2008/004232

§ 371 Date: Jul. 28, 2010

(30) Foreign Application Priority Data
Dec. 24, 2007 (GB) 0725202.6

(51) Int. Cl. A23L 2/385; A23P 1/04

(52) U.S. Cl. 426/103; 426/89; 426/590

(57) ABSTRACT

The invention relates to beverage capsules, kits comprising beverage capsules and methods for making the same. The beverage capsule comprises a beverage base which is enclosed within an edible shell. In some embodiments the beverage capsule comprises a liquid beverage base having a water activity of no more than 0.7 at 25° C. In other embodiments the beverage capsule is shelf stable and preservative free. In further embodiments the beverage capsule comprises a beverage base enclosed within an edible shell, wherein the beverage capsule comprises a thickening composition as a separate component from the beverage base. In yet further embodiments the beverage capsule comprises a beverage base that comprises glucose and/or glycerine.

### CROSS REFERENCE TO RELATED APPLICATIONS

This is a U.S. national stage of application No. PCT/GB2008/004232, filed on 19 Dec. 2008, the disclosure of which is incorporated herein by reference.

### FIELD

The invention relates to beverage capsules, in particular to beverage capsules in which a beverage base is enclosed within an edible shell.

### BACKGROUND

Beverages such as tea, coffee and hot chocolate are very popular. Instant varieties are commonly prepared by adding a concentrate such as powder, granules or syrup to a hot liquid, usually water or milk. The measuring out of such concentrates can be messy and inconvenient so pre-prepared individual servings are growing in popularity.

EP 0324072 A1 discloses a chocolate beverage capsule containing a water-based chocolate syrup. The syrup described in Example 1 is said to consist of 36.22% High Fructose Corn Syrup (HFCS), 17.31% water, 35.10% sucrose, 10.73% alkalised cocoa, 0.20% xanthan gum, 0.21% salt, 0.22% citric acid and 0.11% potassium sorbate. The capsule is added to hot milk to prepare a chocolate drink.

Since the syrup of EP 0324072 A1 comprises 17.31% water, it would have a high water activity (a_{w}) (estimated to be 0.797 at 25° C.). Higher a_{w} substances tend to support more microorganisms. The syrup contains preservatives (citric acid and potassium sorbate) in order to make the syrup microbiologically stable.

### SUMMARY

In some embodiments, the invention provides a beverage capsule having improved microbiological stability.

In other embodiments, the invention provides an improved process for the preparation of a beverage capsule.

### DETAILED DESCRIPTION

According to a first aspect of the invention there is provided a beverage capsule comprising a liquid beverage base enclosed within an edible shell, wherein the liquid beverage base has a water activity of no more than 0.7 at 25° C.

The water activity of the liquid beverage base in some embodiments may be no more than 0.69, 0.68, 0.67, 0.66 or no more than 0.65 at 25° C. In a particular embodiment, the water activity of the liquid beverage base is 0.69 at 25° C.

The use of a liquid beverage base having a low water activity makes the beverage capsule more microbiologically stable and in turn allows the use of preservatives to be decreased or possibly even omitted altogether. A high water activity was previously considered to be necessary for effective processing of the liquid beverage base.

The edible shell and/or the beverage base may be preservative free. In one embodiment the beverage capsule is preservative free.

The beverage capsule may comprise a thickening composition as a separate component from the beverage base.

The liquid beverage base may comprise glycerine and/or glucose.

The liquid beverage base may be a syrup or paste. Suitable liquid beverage bases include chocolate syrup, coffee syrup and mixtures thereof.

According to a second aspect of the invention there is provided a shelf stable preservative free beverage capsule comprising a beverage base enclosed within an edible shell.

As used herein shelf stable is defined as a shelf life of at least 12 months when stored in a cool dry place (out of direct sunlight).

The beverage capsule may comprise a thickening composition as a separate component from the beverage base.

In one embodiment, the beverage base is a liquid beverage base which has a water activity of no more than 0.7, 0.69, 0.68, 0.67, 0.66 or 0.65 at 25° C. In a particular embodiment, the water activity of the liquid beverage base is 0.69 at 25° C.

The beverage base may comprise glycerine and/or glucose.

The beverage base may be a solid, such as a powder or granules, or a liquid, such as a syrup or paste. Suitable solid beverage bases include cocoa powder/granules, hot/drinking chocolate powder/granules, coffee powder/granules, instant tea powder/granules, and soup powder/granules. Suitable liquid beverage bases include chocolate syrup, coffee syrup and mixtures thereof.

According to a third aspect of the invention there is provided a beverage capsule comprising a beverage base enclosed within an edible shell, wherein the beverage capsule comprises a thickening composition as a separate component from the beverage base.

According to a fourth aspect of the invention, there is provided a method for the preparation of a beverage capsule comprising:

providing an edible shell;

providing a beverage base;

providing a thickening composition; and

sealing the beverage base within the edible shell to form a capsule

wherein the thickening composition is provided as a separate component from the beverage base.

A thickening composition (thickener) may be employed to prepare a beverage with a luxurious creamy texture and is particularly useful when the beverage base is intended to be added to water.

The method may involve pumping a flowable beverage base into the edible shell (or pumping a flowable beverage base with the material forming the edible shell in the case of a one-shot process). If the thickener is present in the beverage base it increases the viscosity of the base making it difficult to pump. Previously the beverage base has been diluted to improve processing and preservatives added to compensate for the increased water content and lack of microbiological stability. It will be understood that having the thickener as a separate component does not adversely increase the viscosity of the beverage base.

The thickening composition may be microencapsulated. The thickening composition (microencapsulated or not) may be present in admixture with the beverage base, for example as a solid inclusion or inclusions dispersed within the beverage base or otherwise co-located within the shell (e.g. partitioned from the beverage base). Thus it will be apparent to the skilled person that reference to the thickening composition being a separate component from the base merely requires that the base and the thickening composition are physically distinct and separable such that the base is not thickened by the thickening composition prior to formation of a beverage.

The thickening composition may be incorporated into an edible material. The edible material incorporating the thickening composition may be used to form the edible shell or part of the edible shell, to form a coating on the inside or the outside of the edible shell or to form a separate unit within the edible shell. Suitable edible materials include confectionery materials such as chocolate, in particular milk chocolate and dark chocolate, and cocoa mass. In a particular embodiment, the thickener is incorporated into molten chocolate which is then formed into chocolate beads. The chocolate beads comprising thickener can be dispersed within the shell, within the beverage base or could be incorporated into a coating which is applied to the inner or outer surface of the edible shell.

In a particular embodiment, the thickening composition is a hydrocolloid. A hydrocolloid is a hydrophilic polymer containing many hydroxyl groups. Suitable hydrocolloids include starch, sodium carboxymethyl cellulose (CMC), pectin, acacia gum, guar gum, locust bean gum, carageenan, gelatine and xanthan gum. In a certain embodiment, the thickening composition is selected from xanthan gum, carageenan gum or carboxymethyl cellulose.

In one embodiment, the beverage base has a water activity of no more than 0.7, 0.69, 0.68, 0.67, 0.66 or 0.65 at 25° C. In a particular embodiment, the water activity of the liquid beverage base is 0.69 at 25° C.

The edible shell and/or the beverage base may be preservative free. In one embodiment the beverage capsule is preservative free.

The beverage base may comprise glycerine and/or glucose.

The beverage base may be a solid, such as a powder or granules, or a liquid, such as a syrup or paste. Suitable solid beverage bases include cocoa powder/granules, hot/drinking chocolate powder/granules, coffee powder/granules, instant tea powder/granules, and soup powder/granules. Suitable liquid beverage bases include chocolate syrup, coffee syrup and mixtures thereof.

According to a fifth aspect of the invention there is provided a beverage capsule comprising a beverage base enclosed within an edible shell wherein the beverage base comprises glucose.

The beverage base may comprise at least 15 wt % glucose, or least 20 wt % glucose or at least 30 wt % glucose.

Whilst not wishing to be bound by theory, the use of glucose in the beverage base is considered to render the beverage base more microbiologically stable. Glucose is thought to be a better barrier to microbial growth than sucrose.

The beverage capsule may comprise a thickening composition as a separate component from the beverage base.

In one embodiment, the beverage base is a liquid beverage base which has a water activity of no more than 0.7, 0.69, 0.68, 0.67, 0.66 or 0.65. In a particular embodiment, the water activity of the liquid beverage base is 0.69 at 25° C.

The edible shell and/or the beverage base may be preservative free. In one embodiment the beverage capsule is preservative free.

The beverage base may comprise glycerine.

The beverage base may be a solid, such as a powder or granules, or a liquid, such as a syrup or paste. Suitable solid beverage bases include cocoa powder/granules, hot/drinking chocolate powder/granules, coffee powder/granules, instant tea powder/granules, and soup powder/granules. Suitable liquid beverage bases include chocolate syrup, coffee syrup and mixtures thereof.

According to a sixth aspect of the invention there is provided a beverage capsule comprising a beverage base enclosed within an edible shell, wherein the beverage base comprises glycerine.

Whilst not wishing to be bound by theory, the use of glycerine in the beverage base is considered to assist in lowering the water content of the beverage base and hence render the beverage base more microbiologically stable.

The beverage capsule may comprise a thickening composition as a separate component from the beverage base.

In one embodiment, the beverage base has a water activity of no more than 0.7, 0.69, 0.68, 0.67, 0.66 or 0.65. In a particular embodiment, the water activity of the liquid beverage base is 0.69 at 25° C.

The edible shell and/or the beverage base may be preservative free. In one embodiment the beverage capsule is preservative free.

The beverage base may comprise glucose.

In a seventh aspect of the invention, there is provided a kit for the preparation of a beverage comprising

a beverage capsule as described above in relation to any aspects of the invention, and

a portion of thickening composition.

The thickening composition (thickener) is present as a separate portion and so, in some embodiments, a thickener may be omitted from the beverage capsule. Alternatively, in other embodiments, a thickening composition may be present both in the beverage capsule and as a separate portion. In either case the consumer may add thickener in a quantity sufficient to obtain a desired thickness of beverage. There is no need for the beverage base to contain a thickener so, where the capsule is prepared by pumping the beverage base, the beverage capsule will be more easily prepared.

The following comments refer to a beverage capsule in accordance with any aspect of the present invention.

The edible shell may be prepared from any foodstuff. In a particular embodiment, the edible shell is a chocolate shell.

The term ‘chocolate’ in the context of the present invention is not restricted by the various definitions of chocolate provided by government and regulatory bodies. A chocolate is simply a product obtained from cocoa products and sweeteners.

The edible shell may be any convenient shape, for example it may be tubular, disc-shaped, spherical, lozenge-shaped or cuboid.

The edible shell may have a line of weakness. In this way, the resulting beverage capsule may be opened by hand and the contents may be viewed.

A flavouring composition may be incorporated into the edible shell, the beverage base or both. For example, a liquid beverage base may comprise a flavouring syrup (e.g. hazelnut, vanilla or caramel syrup).

The beverage base may be aerated. When the beverage capsule comprises an aerated base, the resulting beverage base may have a pleasing ‘foamy’ appearance. The beverage base may be aerated by the addition of whipping agents such as egg white or albumen.

The beverage base may comprise one or more of cocoa powder (including reduced fat cocoa powder), skimmed milk powder, a sweetener, salt and emulsifiers, such as lecithin or polyglycerol polyricinoleate (PGPR).

Suitable sweeteners include sugars, sugar alcohols, intense sweeteners, and any combination thereof. In a particular embodiment, the sweetener is glucose, iso glucose (also known as High Fructose Corn Syrup), maltose syrup or a combination thereof. When both glucose and iso glucose are present in the beverage base, the ratio of glucose to iso glucose (G:I) may be from 1:99 to 60:40, from 10:90 to 55:45, from 20:80 to 50:50, or from 30:70 to 45:55.

In a particular embodiment, the beverage base is sucrose-free.

The weight ratio of shell to beverage base in the beverage capsule may be from 25:75 to 75:25, from 40:60 to 60:40 or about 50:50.

The beverage base may be deposited within the edible shell using conventional techniques, including traditional shell making, a frozen cone process and a one-shot process.

The beverage capsule may be mixed with a hot liquid, such as water or milk, in order to prepare a beverage. Alternatively, the beverage base may be mixed with a cold liquid, such as water or milk and then heated (for example, in a microwave oven) in order to prepare a beverage.

It will be understood that the invention also resides in the preparation of the beverage capsules as herein described.

Embodiments of the invention will now be described by way of example only.

### Methodology

### Beverage Base

The liquid ingredients (e.g. glucose (80.5% dry solids), iso glucose (71% dry solids), very high maltose syrup (VHMS) and glycerine) were mixed together at approximately 43 to 50° C. in the ratios provided. The dry ingredients (e.g. reduced fat cocoa powder, skimmed milk powder (SMP) and salt) were either pre-blended and then gradually mixed with the liquid ingredients or gradually added one at a time to the liquid ingredients (salt before cocoa powder). The beverage base may be prepared on a hot plate or, more conveniently, a jacketed Hobart mixer is employed to maintain the temperature of the mixture. Alternatively, the beverage base may be prepared using a Bühler mixer.

The weight ratios of the ingredients used to prepare the beverage bases are shown in the table below together with the glucose:iso glucose ratio.

TABLE 1

| | Glucose | Iso glucose | Cocoa powder | SMP | Glycerine | Salt | VHMS | G:I (%) |
|---|---|---|---|---|---|---|---|---|
| Base 1 | 40.0 | 40.0 | 15.0 | 5.0 | 0 | 0 | 0 | 50:50 |
| Base 2 | 36.0 | 43.0 | 21.0 | 0 | 0 | 0 | 0 | 46:54 |
| Base 3 | 25.0 | 52.0 | 23.0 | 0 | 0 | 0 | 0 | 32:68 |
| Base 4 | 15.0 | 60.0 | 25.0 | 0 | 0 | 0 | 0 | 20:80 |
| Base 5 | 10.0 | 65.0 | 25.0 | 0 | 0 | 0 | 0 | 13:87 |
| Base 6 | 0 | 75.0 | 25.0 | 0 | 0 | 0 | 0 | 0:100 |
| Base 7 | 0 | 65.0 | 25.0 | 10.0 | 0 | 0 | 0 | 0:100 |
| Base 8 | 29.0 | 50.0 | 21.0 | 0 | 0 | 0 | 0 | 37:63 |
| Base 9 | 25.0 | 54.0 | 21.0 | 0 | 0 | 0 | 0 | 32:68 |
| Base 10 | 27.0 | 51.0 | 22.0 | 0 | 0 | 0 | 0 | 35:65 |
| Base 11 | 27.0 | 52.0 | 21.0 | 0 | 0 | 0 | 0 | 34:66 |
| Base 12 | 0.0 | 71.0 | 24.0 | 0 | 5.0 | 0 | 0 | 0:100 |
| Base 13 | 10.0 | 62.0 | 3.0 | 0 | 5.0 | 0 | 0 | 14:86 |
| Base 14 | 28.0 | 51.0 | 21.0 | 0 | 0 | 0 | 0 | 35:65 |
| Base 15 | 35.6 | 42.6 | 20.8 | 0 | 1.0 | 0 | 0 | 46:54 |
| Base 16 | 27.7 | 50.5 | 20.8 | 0 | 1.0 | 0 | 0 | 35:65 |
| Base 17 | 27.6 | 50.7 | 20.9 | 0 | 0.5 | 0 | 0 | 35:65 |
| Base 18 | 25.0 | 41.0 | 21.0 | 0 | 1.0 | 0 | 12.0 | 38:62 |
| Base 19 | 25.0 | 41.0 | 21.0 | 0 | 1.0 | 0.3 | 11.7 | 38:62 |
| Base 20 | 39.7 | 39.7 | 5.0 | 14.9 | 0 | 0.8 | 0 | 50:50 |
| Base 21 | 36.0 | 42.0 | 21.2 | 0 | 0 | 0.8 | 0 | 46:54 |
| Base 22 | 25.0 | 47.2 | 12.0 | 15.4 | 0 | 0.4 | 0 | 35:65 |
| Base 23 | 14.0 | 57.2 | 15.0 | 13.4 | 0 | 0.4 | 0 | 20:80 |
| Base 24 | 8.0 | 61.2 | 17.0 | 13.4 | 0 | 0.4 | 0 | 12:88 |
| Base 25 | 4.0 | 65.2 | 17.0 | 13.4 | 0 | 0.4 | 0 | 6:94 |
| Base 26 | 0 | 69.2 | 17.0 | 13.4 | 0 | 0.4 | 0 | 0:100 |
| Base 27 | 0 | 69.2 | 17.0 | 13.5 | 0 | 0.3 | 0 | 0:100 |
| Base 28 | 23.0 | 42.0 | 22.0 | 0 | 1.0 | 0 | 12.0 | 35:65 |
| Base 29 | 22.8 | 41.6 | 21.8 | 0 | 1.5 | 0.4 | 11.9 | 35:65 |

The water activities for a selection of the beverage bases, measured at 25° C., are shown in the table below.

TABLE 2

| | Water activity |
|---|---|
| Base 2 | 0.68 |
| Base 8 | 0.69 |
| Base 10 | 0.72 |
| Base 11 | 0.79 |
| Base 12 | 0.71 |
| Base 14 | 0.69 |
| Base 16 | 0.69 |
| Base 17 | 0.69 |

### Edible Shell

The shell is formed from either standard milk chocolate (Cadbury Dairy Milk™) or standard milk chocolate into which xanthan gum has been milled as thickener for the beverage base. The shell is formed using standard shell forming equipment.

### Preparation

The beverage base is deposited into the part chocolate shell using standard deposition at 38 to 40° C. and the shell is then backed off using chocolate to form a sealed capsule. The sealed capsules are then cooled and demoulded.

### Thickener

When thickener is present in the beverage capsules, it is added as part of the shell (as mentioned above) or it is added to chocolate, which is then coated onto the shell or deposited to form one or more small units (e.g. beads) which are placed inside the shell with the beverage base. It will be understood that the quantity of the thickener that is added is dependent upon the degree of thickening required in the final beverage.

The weight ratios of the ingredients used to prepare the various chocolate compositions are shown in the table below.

TABLE 3

| | Standard milk chocolate | Xanthan gum |
|---|---|---|
| Chocolate 1 | 100 | 0 |
| Chocolate 2 | 99 | 1 |
| Chocolate 3 | 98 | 2 |
| Chocolate 4 | 97 | 3 |
| Chocolate 5 | 96 | 4 |
| Chocolate 6 | 95 | 5 |
| Chocolate 7 | 94 | 6 |
| Chocolate 8 | 93 | 7 |
| Chocolate 9 | 92 | 8 |
| Chocolate 10 | 91 | 9 |
| Chocolate 11 | 90 | 10 |

### Examples 1 to 19

Beverage capsules are prepared using beverage bases 1 to 19 and shells prepared from Chocolate 1 (no thickener). The resulting capsules comprise 10 g beverage base and 15 g shell. The capsules are added to hot milk to produce a chocolate flavour beverage.

### Examples 20 to 27

Beverage capsules are prepared using beverage bases 20 to 27 and shells prepared from Chocolate 6 (containing 5 wt % xanthan gum). The xanthan gum is effectively encapsulated by the chocolate and has no thickening effect on the beverage base which can be pumped as before. The resulting capsules comprise 10 g beverage base and 15 g shell. The capsules are added to hot water to produce a chocolate flavour beverage.

### Examples 28 to 37

Beverage capsules are prepared using beverage bases 20 to 29, shells prepared from Chocolate 1 (without xanthan gum), and small pieces (beads) of Chocolate 6 (containing 5 wt % xanthan gum). The xanthan gum is effectively encapsulated by the chocolate and has no thickening effect on the beverage base which can be pumped as before. The resulting capsules comprise 10 g beverage base and 15 g shell. The capsules are added to hot water to produce a chocolate flavoured beverage.

### Example 38

A beverage capsule is prepared using base 1 and a shell prepared from Chocolate 1 (no thickener). The shell is provided with a line of weakness so that the capsule can be broken in half and the contents viewed. Once broken, the two halves are added to hot milk to prepare a chocolate flavoured beverage.

### Example 39

A beverage capsule is prepared using base 29 and a shell prepared from Chocolate 1 (no thickener). The beverage capsule is added to hot water and then a quantity of chocolate beads prepared from Chocolate 5 (4% thickener) are added to prepare a chocolate flavoured beverage.

1. A beverage capsule comprising a liquid beverage base enclosed within an edible shell, wherein the liquid beverage base has a water activity of no more than 0.7 at 25° C.

2. A shelf stable preservative free beverage capsule comprising a beverage base enclosed within an edible shell.

3. A beverage capsule comprising a beverage base enclosed within an edible shell, wherein the beverage capsule comprises a thickening composition as a separate component from the beverage base.

4. A beverage capsule comprising a beverage base enclosed within an edible shell wherein the beverage base comprises glucose.

5. The capsule of claim 4, wherein the beverage base comprises at least 15 wt % glucose.

6. A beverage capsule comprising a beverage base enclosed within an edible shell, wherein the beverage base comprises glycerine.

7. The capsule of claim 6, wherein the beverage base comprises at least 0.5 wt % glycerine.

8. The capsule of claim 2, wherein the beverage base has a water activity of no more than 0.7 at 25° C.

9. The capsule of claim 1, wherein the beverage base is preservative free.

10. The capsule of claim 1, additionally comprising a thickening composition as a separate component from the beverage base.

11. The capsule of claim 1, wherein the beverage base comprises glucose.

12. The capsule of claim 1, wherein the beverage base comprises glycerine.

13. The capsule of claim 1, wherein the edible shell is a chocolate shell.

14. The capsule of claim 1, wherein the edible shell has a line of weakness.

15. The capsule of claim 1, wherein the beverage base is aerated.

16. The capsule of claim 1, wherein the beverage base comprises glucose and iso glucose and the ratio of glucose to iso glucose is from 1:99 to 60:40.

17. A method for the preparation of a beverage capsule comprising:
(i) providing an edible shell;
(ii) providing a beverage base;
(iii) providing a thickening composition; and
(iv) sealing the beverage base within the edible shell to form a capsule
wherein the thickener is provided as a separate component from the beverage base.

18. A kit for the preparation of a beverage comprising a beverage capsule in accordance with any claim 1, and
a portion of a thickening composition.
